(19) United States
(12) Patent Application Publication
(10) Pub. No.: US 2026/0218851 A1
(43) Pub. Date: Jul. 30, 2026

(54) Portable Umbrella Holder and Related Methods

(71) Applicant: Kajatharine Hurst, Birmingham, AL (US)

(72) Inventor: Kajatharine Hurst, Birmingham, AL (US)

(21) Appl. No.: 19/037,146

(22) Filed: Jan. 25, 2025

(51) Int. Cl. F16M 13/02; A45B 19/04

(52) U.S. Cl. CPC F16M 13/022; A45B 19/04; A45B 2200/1009

(57) ABSTRACT

A portable umbrella holder is designed to provide hands-free use of an umbrella during inclement weather. It features a clip formed as a horizontal hollow tube that secures the holder to an object, and an adjustable pole that engages the handle of an umbrella. The adjustable pole can be a telescopic tube and is configured to extend vertically at a perpendicular angle to the clip, positioning the umbrella above the user for optimal protection,

### TECHNICAL FIELD

The present disclosure relates to a portable umbrella holder, and more particularly, to an apparatus designed to secure an umbrella during inclement weather while allowing the user to remain hands-free.

### BACKGROUND

In today's fast-paced world, individuals often find themselves multitasking and needing to perform various activities while on the go. This is especially true in urban environments where people frequently commute by foot, bicycle, or public transportation, One common challenge faced by individuals in such settings is dealing with unexpected weather changes, particularly rain. While umbrellas are a popular solution for staying dry, they require one hand to hold, which can be inconvenient when both hands are needed for other tasks, such as carrying bags, using a smartphone, or holding onto a handrail.

The need for a hands-free solution to manage umbrellas during rain has become increasingly apparent. Traditional umbrella designs do not accommodate the need for mobility and multitasking, often leaving users struggling to balance their belongings and maintain their dryness. This has led to a demand for innovative solutions that allow individuals to remain dry while keeping their hands free for other activities. The development of a portable umbrella holder addresses this need by providing a practical and efficient way to secure an umbrella without occupying the user's hands, thus enhancing convenience and functionality in everyday life.

### SUMMARY

The portable umbrella holder may include a clip designed as a horizontal hollow tube, which can secure the holder to an object. An adjustable pole may engage the handle of an umbrella, securing it for hands-free use during inclement weather.

The clip of the portable umbrella holder may be designed to facilitate hands-free use of the umbrella.

The adjustable pole of the portable umbrella holder can be a telescopic tube, allowing for easy adjustment.

The adjustable pole may be configured to protect the user from adverse weather conditions by securing the umbrella.

The adjustable pole can extend vertically at a right angle to the clip, providing stability and positioning.

When the adjustable pole extends vertically at a right angle, it may position the umbrella above the user, offering optimal coverage.

The method of using the portable umbrella holder may involve securing the clip, designed as a horizontal hollow tube, to an object. The handle of an umbrella can be engaged with the adjustable pole, scouring the umbrella for hands-free use during bad weather.

Securing the clip to an object may allow for hands-free use of the umbrella, enhancing convenience.

The adjustable pole in the method can include a telescopic tube, facilitating easy adjustment and use.

Engaging the umbrella handle with the adjustable pole may protect the user from adverse weather conditions.

The method may also involve extending the adjustable pole vertically at a right angle to the clip, ensuring proper positioning.

Extending the adjustable pole vertically at a right angle can position the umbrella above the user, providing effective coverage.

The portable umbrella holder may also include a means for securing it to an object, formed as a horizontal hollow tube, and a means for engaging the umbrella handle, allowing hands-free use during bad weather.

The method for securing the portable umbrella holder may be designed to facilitate hands-free use of the umbrella.

During engagement of umbrella handle, a telescopic tube will receive the umbrella handle, allowing for easy adjustment.

The method of operation is configured to protect the user from adverse weather conditions by securing the umbrella.

In use, the engagement will extend vertically at a right angle for securing and providing stability and proper positioning

While in use, the umbrella will be positioned above the user, offering optimal coverage.

### BRIEF DESCRIPTION OF DRAWINGS

The accompanying drawings illustrate the various embodiments of systems, methods, and other aspects of the disclosure. Any person with ordinary skill in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another and vice versa. Further, the elements may not be drawn to scale, The illustrative embodiments will hereinafter be described in accordance with the appended drawings in accordance with 35 U.S.C. § 112, which are provided to illustrate and not to limit the scope in any manner, wherein similar designations denote similar elements, and in which:

FIG. 1 is a perspective view of a portable umbrella holder in a accordance with at least one embodiment.

FIG. 2 is a method of securing and adjusting an umbrella holder in at least one embodiment.

### DETAILED DESCRIPTION

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment.

Reference throughout this document to “tubular segments”, or similar terms refers to a various-sections that make up portions of the apparatus. Thus, the appearances of such phrases or in various places throughout this specification are not necessarily all referring to the same embodiment. Furthermore, the particular features, structures, or characteristics may be combined in any suitable manner in one or more embodiments without limitation.

Furthermore, the particular features, structures, or characteristics may be combined in any suitable manner in one or more embodiments without limitation. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural changes may be made without departing from the scope of the particular inventions. Accordingly, one skilled in the art will recognize that one or more of the inventions may be practiced with various modifications and alterations Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Materials described or referenced herein will sometimes be described in singular form for. clarity. However, it should be appreciated that particular embodiments may include multiple instantiations of a material unless noted otherwise. Surfaces in some embodiments can be understood as representing segments or portions of those embodiments. Alternate implementations are included within the scope of embodiments of the present invention would be understood by those having ordinary skill in the art.

Headings of sections provided in this patent application and the title of this patent application are for convenience only and are not to be taken as limiting the disclosure in any way. A description of an embodiment with several components in connection with each other does not imply that all such components are required.

The disclosure provides a portable umbrella holder designed for hands-free use during inclement weather. The system may include a clip formed as a horizontal hollow tube, which can secure the holder to an object 2. An adjustable pole, which may be a telescopic tube, can engage the handle of an umbrella 3, securing it in place. This configuration allows the umbrella 3 to be positioned above the user, providing protection from bad weather, The telescopic tube can extend vertically at a perpendicular angle to the clip, supporting the umbrella 3 in an upright position. The holder may be useful for users who need to keep their hands free while staying protected from the elements.

The portable umbrella holder may include a clip 1 that is formed as a horizontal hollow tube. This clip 1 may be configured to secure the portable umbrella holder to an object, allowing for the attachment or holding of components together. The clip may be designed to facilitate hands-free use of the umbrella 3, which can be advantageous during inclement weather when the user may be occupied. The horizontal hollow tube will serve as a structural component that provides stability and support to the umbrella holder. The clip's configuration may allow it to be easily attached to various objects, ensuring that the umbrella 3 remains securely in place. In a non-limiting example, the clip 1 may be designed to accommodate various shapes and sizes of objects. The design of the clip may also enable it to accommodate different sizes and shapes of objects, enhancing its versatility and usability. The clip's ability to hold the umbrella 3 in a fixed position may ensure that the user remains protected from the elements without needing to manually hold the umbrella 3. The horizontal hollow tube may be constructed from materials that provide durability and resistance to environmental factors, ensuring that the umbrella holder remains functional over time. The clip's design may also incorporate features that allow for easy adjustment or repositioning, providing the user with flexibility in how the umbrella 3 is positioned. The overall configuration of the clip may contribute to the effectiveness of the portable umbrella holder in providing hands-free protection from bad weather.

The handle of an umbrella 3 may be engaged by a telescopic tube 4, which can secure the umbrella 3. This engagement allows the umbrella 3 to be held in place, potentially providing hands-free use during adverse weather conditions. The telescopic tube 4 may be designed to extend vertically at a perpendicular angle, which can support the umbrella 3 in an upright position. This configuration may ensure that the umbrella 3 is positioned above the user, offering protection from rain. The telescopic tube 4 may be formed as part of a portable umbrella holder, which can be attached to an object 2 using a clip. The portable umbrella holder may be used by individuals who are occupied, allowing them to remain hands free while the umbrella 3 is secured. This system may be useful during bad weather, as it can provide a reliable means of securing an umbrella 3 without requiring the user to hold it manually. The design may incorporate a telescopic tube 4, which can be adjusted to accommodate different umbrella sizes and user preferences. The portable umbrella holder is versatile, allowing it to be used in various settings and conditions.

The telescopic tube 4 may be configured to extend vertically at a perpendicular angle, which may support the umbrella 3 in an upright position. This configuration may allow the umbrella to be positioned above the user, potentially providing protection from bad weather. The telescopic tube 4 may engage the handle of an umbrella 3, which may secure the umbrella 3 and allow for hands-free use. The telescopic tube 4 may be part of a portable umbrella holder, which may be designed to secure the umbrella 3 during bad weather while the user is occupied. The telescopic tube's ability to extend vertically at a perpendicular angle may be important in maintaining the umbrella's position and providing effective coverage. The design may be intended to facilitate ease of use and convenience for the user, allowing them to remain hands-free while being protected from the elements.

In an embodiment, the user may benefit from this hands-free operation, as the umbrella holder may secure the umbrella 3 without requiring manual intervention, As mentioned previously, the portable umbrella holder may thus offer a practical solution for individuals needing to manage tasks in the rain without holding an umbrella handle 3 manually.

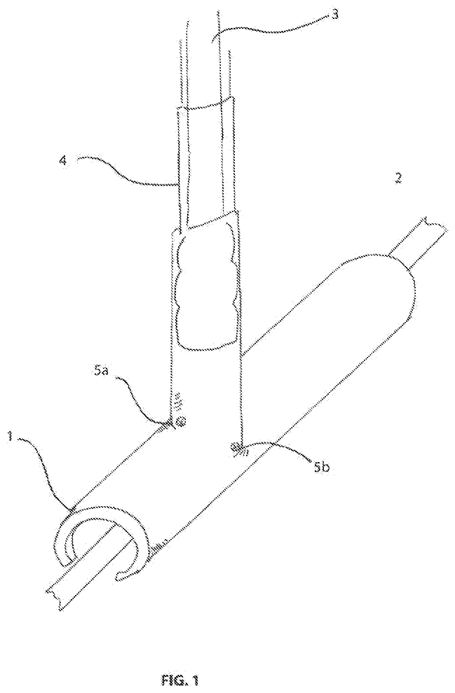

Turning now to FIG. 1, is a perspective view of a portable umbrella holder in an accordance with at least one embodiment. As shown illustrates a perspective view of the embodiment while in use, with a portion of a standard umbrella handle 3 inserted into the telescopic tube 4. The illustration shows a clip 1 secured to an adjacent object 2. The illustration further shows the telescopic tube 4 with a plurality of tubular segments comprising individual segments of varying sizes coupled together to allow for expansion and retraction by slidably pulling the two opposite ends of the telescopic tube 4 In the preferred embodiment, a first tubular segment, a second tubular segment, and a third tubular segment are slidably connected together. The illustration also shows at least two rotation provisions (5a,5b), that allows the apparatus to fold at the clip 1 for adjustment.

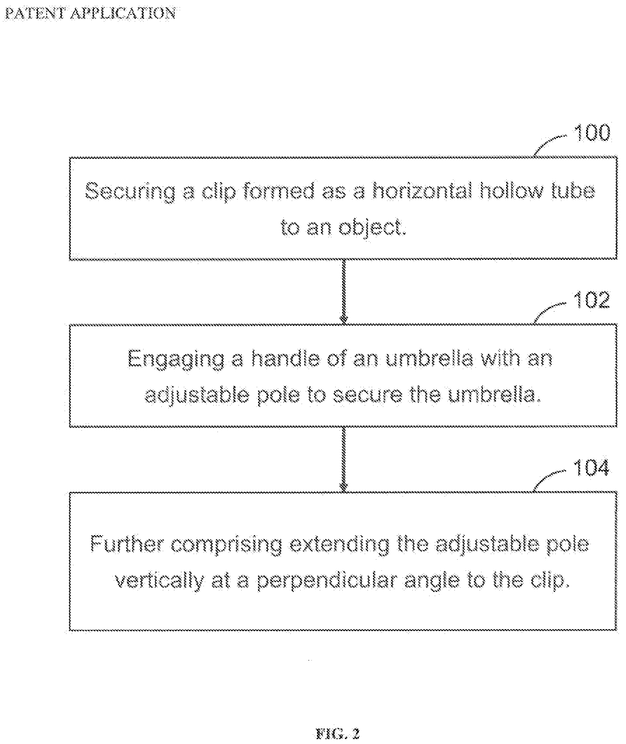

Turning now to FIG. 2 is a flowchart illustrating a method in step 100 for securing a portable umbrella holder to an object, according to an embodiment. At step 100, the clip, which may be formed as a horizontal hollow tube, can be secured to an object. This may allow for the hands-free use of the umbrella, which can be advantageous during inclement weather when the user may be occupied. The clip, as described, may serve the function of attaching or holding components together, ensuring that the umbrella remains stable and secure. The horizontal hollow tube configuration of the clip may facilitate this attachment, providing a reliable means of securing the umbrella holder to various objects. The potential for hands-free operation may be a benefit, allowing the user to remain engaged in other activities while being protected from the elements. The design and functionality of the clip, as well as its interaction with the object, may be important in achieving the desired outcome of hands-free umbrella use.

In the context of step 102, the process may involve engaging a handle of an umbrella with an adjustable pole to secure the umbrella. This may be facilitated by the adjustable pole, which is potentially a telescopic tube 4, allowing for the securement of the umbrella handle. The telescopic nature of the pole may provide the adjustability to accommodate various umbrella handle sizes and shapes, ensuring a snug fit. This engagement may serve the function of securing the umbrella 3, thereby enabling hands-free use during inclement weather conditions. The adjustable pole, by virtue of its telescopic design, may also contribute to the protection of the user from adverse weather by maintaining the umbrella in a stable position, The user, while being occupied, may benefit from this hands-free operation, as the umbrella remains securely held by the telescopic tube 4. The telescopic tube's ability to engage the handle of the umbrella may be important in providing the necessary stability and support, ensuring that the umbrella remains upright and effectively shields the user from rain or other weather elements. This configuration may allow the user to perform other tasks without the need to manually hold the umbrella, thus enhancing convenience and functionality.

In the context of the portable umbrella holder, the process may involve extending the adjustable pole vertically at a perpendicular angle to the clip 1. This may facilitate the positioning of the umbrella above the user, potentially providing protection from adverse weather conditions. The adjustable pole, which may be a telescopic tube 4, can be extended to achieve the desired vertical orientation. This configuration may allow the umbrella to be held securely in place, ensuring hands-free operation for the user. The clip 1, formed as a horizontal hollow tube, may serve as the attachment point for the adjustable pole, providing stability and support. The telescopic nature of the pole may allow for adjustments in height, accommodating users of varying statures and ensuring optimal coverage. The overall design may aim to offer convenience and ease of use, allowing the user to remain protected from the elements while keeping their hands free for other tasks.

What is claimed is:

1. A portable umbrella holder, comprising:
a clip formed as a horizontal hollow tube configured to secure the portable umbrella holder to an object; and
an adjustable pole configured to engage a handle of an umbrella and secure the umbrella, allowing hands-free use of the umbrella during bad weather.

2. The portable umbrella holder of claim 1, wherein the clip is configured to allow hands-free use of the umbrella.

3. The portable umbrella holder of claim 1, wherein the adjustable pole is a telescopic tube.

4. The portable umbrella holder of claim 1, wherein the adjustable pole is configured to protect a user from bad weather.

5. The portable umbrella holder of claim 1, wherein the adjustable pole extends vertically at a perpendicular angle to the clip.

6. The portable umbrella holder of claim 5, wherein the adjustable pole extending vertically at the perpendicular angle is configured to position the umbrella above the user.

7. A method of using a portable umbrella holder, comprising:
securing a clip formed as a horizontal hollow tube to an object; and
engaging a handle of an umbrella with an adjustable pole to secure the umbrella, allowing hands-free use of the umbrella during bad weather.

8. The method of claim 7, wherein securing the clip to the object allows hands-free use of the umbrella.

9. The method of claim 7, wherein the adjustable pole comprises a telescopic tube.

10. The method of claim 7, wherein engaging the handle of the umbrella with the adjustable pole protects a user from bad weather.

11. The method of claim 7, further comprising extending the adjustable pole vertically at a perpendicular angle to the clip.

12. The method of claim 11, wherein extending the adjustable pole vertically at the perpendicular angle positions the umbrella above the user.

13. A portable umbrella holder, comprising:
a means for securing the portable umbrella holder to an object, the means for securing formed as a horizontal hollow tube; and
a means for engaging a handle of an umbrella and securing the umbrella, the means for engaging allowing hands-free use of the umbrella during bad weather.

14. The portable umbrella holder of claim 13, wherein the means for securing is configured to allow hands-free use of the umbrella.

15. The portable umbrella holder of claim 13, wherein the means for engaging comprises a telescopic tube.

16. The portable umbrella holder of claim 13, wherein the means for engaging is configured to protect a user from bad weather.

17. The portable umbrella holder of claim 13, wherein the means for engaging extends vertically at a perpendicular angle to the means for securing.

18. The portable umbrella holder of claim 17, wherein the means for engaging extending vertically at the perpendicular angle is configured to position the umbrella above the user.
